(19) United States
(12) Patent Application Publication
(10) Pub. No.: US 2016/0104957 A1
(43) Pub. Date: Apr. 14, 2016

(54) Connector Assembly

(71) Applicant: Tyco Electronics AMP Korea Ltd, Gyungsangbuk-do (KR)

(72) Inventors: Jung Hoon Kim, Gyunsangbuk-do (KR); Hye Jun Lee, Gyungsangbuk-do (KR)

(73) Assignee: Tyco Electronics AMP Korea Ltd, Gyungsan-si (KR)

(21) Appl. No.: 14/875,069

(22) Filed: Oct. 5, 2015

(30) Foreign Application Priority Data
Oct. 10, 2014 (KR) 10-2014-0136764
Nov. 13, 2014 (KR) 10-2014-0157849
Jun. 18, 2015 (KR) 10-2015-0086589

(51) Int. Cl. H01R 12/70; H01R 4/02; H01R 13/6581; H01R 13/52

(52) U.S. Cl. CPC H01R 12/7076; H01R 13/5202; H01R 4/02; H01R 13/6581

(57) ABSTRACT

A connector assembly is disclosed. The connector assembly has a seamless tube housing, a terminal portion disposed inside the housing and including a plurality of connection terminals, a sealing member disposed along a circumference of a front end portion of the housing, the front end portion of the housing connecting to a mating connector, a flange formed at the front end portion of the housing adjacent to the sealing member, and a cover shell covering an outer side of the housing.

### CROSS-REFERENCE TO RELATED APPLICATIONS

This application claims the benefit of the filing date under 35 U.S.C. §119(a)-(d) to Korean Patent Application No. 10-2014-0136764, filed on Oct. 10, 2014, Korean Patent Application No. 10-2014-0157849, filed on Nov. 13, 2014, and Korean Patent Application No. 10-2015-0086589, filed on Jun. 18, 2015, in the Korean Intellectual Property Office, the disclosures of which are incorporated herein by reference.

### FIELD OF THE INVENTION

The invention relates to a connector assembly, and more particularly to a waterproof connector assembly for a mobile communication terminal.

### BACKGROUND

A conventional mobile communication terminal is equipped with various functions, for example, a call function through a voice or a speech, a video call function, an information input and output function, and a data storage function. Recently, such a mobile communication terminal provides more complicated functions in addition to the call function, such as a photograph and video capturing function, a music or video file playing function, a game function, and a broadcasting receiving function, and a function of a storage medium involved with personal information and credit payment.

Due to the various additional functions being provided in the mobile communication terminal, a connector may be necessary for inputting and outputting data and connecting peripheral devices. The connector may include, as necessary, a universal serial bus (USB) port for transmitting data in the mobile communication terminal, an earphone, a remote controller, and an input and output port for interfacing with peripherals such as a television (TV).

Known connectors may include a sealing member for waterproofing. Such a sealing member may be formed with an elastic material such as rubber and provided between connectors. When the connectors are connected, the sealing member may be deformed and compressed therebetween to maintain waterproofness and tightness of portions on which the connectors are connected. However, such an existing connector may have a free play, for example, a gap, formed between the sealing member and an inner wall of the connector and thus, may not be fully waterproof.

### SUMMARY

The object of the invention is to provide a more thoroughly waterproof connector assembly. The disclosed connector assembly has a seamless tube housing, a terminal portion disposed inside the housing and including a plurality of connection terminals, a sealing member disposed along a circumference of a front end portion of the housing, the front end portion of the housing connecting to a mating connector, a flange formed at the front end portion of the housing adjacent to the sealing member, and a cover shell covering an outer side of the housing.

### BRIEF DESCRIPTION OF THE DRAWINGS

The invention will now be described by way of example with reference to the accompanying figures of which:

FIG. 1 is a perspective view of a connector assembly according to an embodiment of the invention;

FIG. 2 is an exploded perspective view of the connector assembly of FIG. 1.

FIG. 3 is a cross-sectional view of the connector assembly of FIG. 1.

FIG. 4 is a perspective view of a connector assembly according to another example embodiment;

FIG. 5 is an exploded perspective view of the connector assembly of FIG. 4.

FIG. 6 is a perspective view of a connector assembly according to a further example embodiment; and

FIG. 7 is an exploded perspective view of the connector assembly of FIG. 6.

### DETAILED DESCRIPTION OF THE EMBODIMENT(S)

Hereinafter, example embodiments of the invention will be described in detail with reference to the accompanying drawings, wherein like reference numerals refer to like elements. The invention may, however, be embodied in many different forms and should not be construed as being limited to the embodiments set forth herein; rather, these embodiments are provided so that the description will be thorough and complete, and will fully convey the concept of the invention to those skilled in the art. Further, in the description of embodiments, detailed description of well-known related structures or functions will be omitted when it is deemed that such description will cause ambiguous interpretation of the present disclosure.

In addition, terms such as first, second, A, B, (a), (b), and the like may be used herein to describe components. Each of these terms is not used to define an essence, order or sequence of a corresponding component but used merely to distinguish the corresponding component from other component(s). It should be noted that if it is described in the specification that one component is “connected,” “coupled,” or “joined” to another component, a third component may be “connected,” “coupled,” and “joined” between the first and second components, although the first component may be directly connected, coupled or joined to the second component.

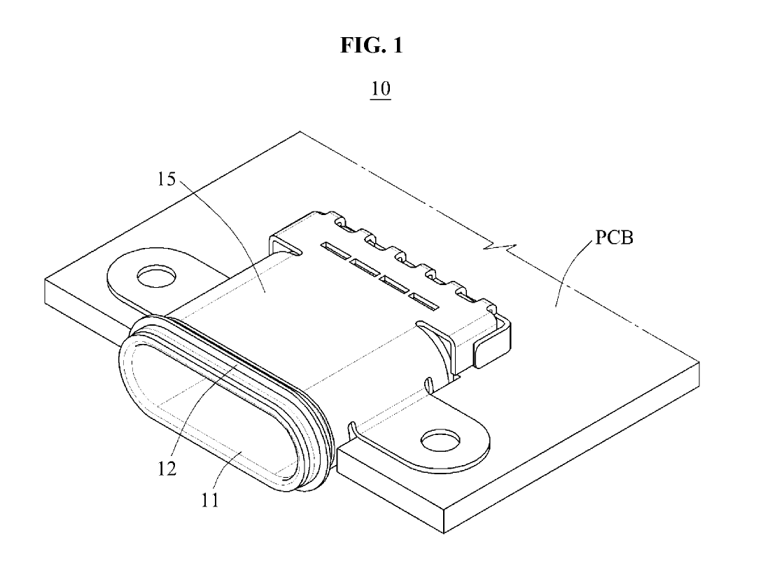

With respect to FIGS. 1-5, the connector assembly 10 includes a housing 11, a terminal portion 13, a sealing member 12 provided along a circumference of a front end portion of the housing 11, and a cover shell 15 provided to cover the housing 11. Hereinafter, the connector assembly 10 will be described focusing on a direction in which the connector assembly 10 is connected to a mating connector, which will be referred to as a “front” or a “front end portion,” and an opposite side to the front or the front end portion will be referred to a “rear” or a “rear end portion.”

The housing 11 is provided in a form of an integral seamless tube to increase a waterproof efficiency. For example, the housing 11 may be formed in an integral type using a deep drawing. However, a method of forming the housing 11 may not be limited to the deep drawing and thus, practically various methods may be used to form the housing 11 in the integral tube form. For example, the housing 11 may be formed by bending a form of a plate formed through punching or bending to be in a cylindrical form, and by forming the cylindrical form to be an integral seamless cylindrical form by connecting positions to be attached to each other through welding or soldering.

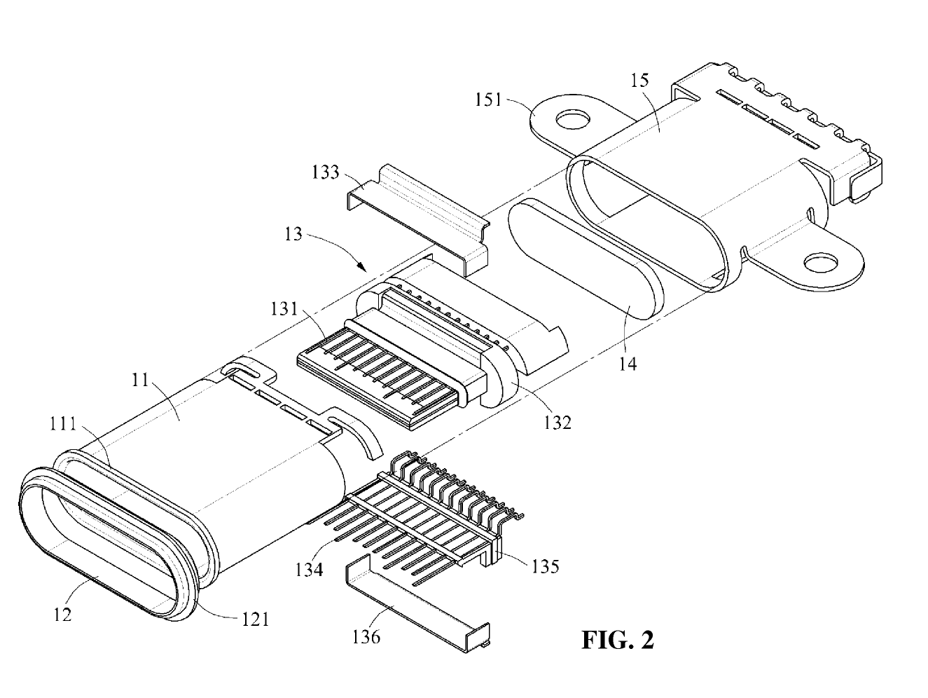

The sealing member 12 is provided in a form of a ring to be inserted to an outer side surface of the housing 11, at the front end portion. The sealing member 12 is formed with an elastic and compressible material, for example, rubber and silicone. To enhance waterproofness and sealing performance, as depicted in FIGS. 2-5, the sealing member 12 includes a protrusion 121 that protrudes at a height along a circumference of an outer circumference surface of the sealing member 12. The protrusion 121 is formed in a direction vertical to a surface of the sealing member 12 and in a direction orthogonal to a direction in which the housing 11 is connected to the mating connector. In addition, the protrusion 121 is formed continuously or discontinuously along a circumference of the sealing member 12. The sealing member 12 may include at least one protrusion 121, and a single circumferential line or a plurality of lines may be formed. For example, when a plurality of protrusions is formed, the protrusions may be formed in parallel to one another at intervals therebetween. However, example embodiments may not be limited thereto, and thus practically various modifications may be made to a size and a disposition of the protrusion 121. According to an embodiment, the protrusion 121 of the sealing member 12 may enable an increase in a contact area of the sealing member 12 and an improvement in a sealing efficiency when the sealing member 12 is compressed between connectors.

The cover shell 15, as depicted in FIGS. 1-5, is formed as a separate component of the housing 11 and connected to an outer side to cover the housing 11. The cover shell 15 serves a function of reinforcing strength of the housing 11 by being connected to the outer side of the housing 11 and reinforcing strength of the connector assembly 10. For example, the cover shell 15 may be provided in a form of covering an upper surface and a side surface of the housing 11 by being connected downwards from above to the upper surface of the housing 11. For another example, the cover shell 15 may be provided in a form of covering a rear surface in addition to the upper surface and the side surface of the housing 11.

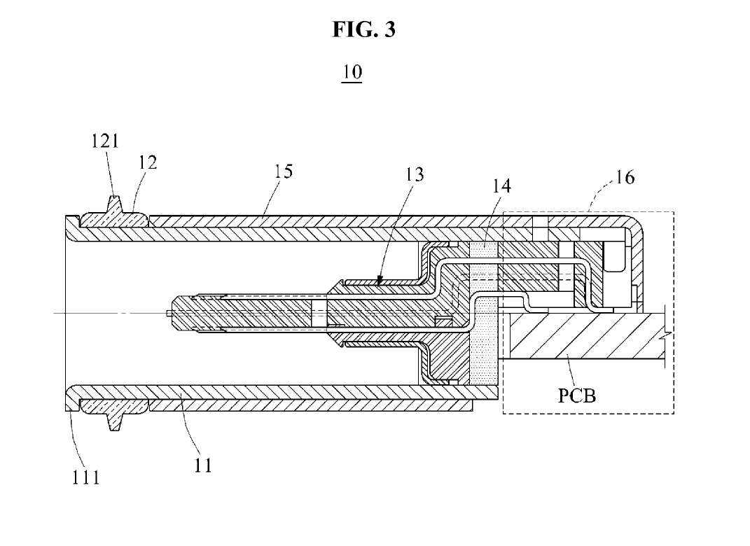

As shown especially in the cross-sectional view of FIG. 3, the cover shell 15 covers an entire portion of the upper surface of the housing 11, excluding a portion to which the sealing member 12 is connected. Thus, as illustrated, a front end portion of the cover shell 15 is in contact with a rear end portion of the sealing member 12, and thus the cover shell 12, for example, the front end portion of the cover shell 15, serves a function as a stopper to prevent rearward pushing of the sealing member 12 from the housing 11.

The cover shell 15, as depicted in FIGS. 2, 4, and 5, includes a connecting portion 151 on each side of the cover shell 15 to connect the connector assembly 10 to a printed circuit board (PCB). For example, the connecting portion 151 may be formed by a portion of a side surface or a rear surface of the cover shell 15 being externally extended and bent. However, example embodiments may not be limited thereto, and practically various modifications may be made to a form of the cover shell 15.

The housing 11 includes the sealing member 12 at the front end portion of the housing 11 for waterproofing, and a flange 111 depicted in FIGS. 2-5 is formed along a circumference of the front end portion of the housing 11 to prevent detaching of the sealing member 12. Thus, as illustrated especially in FIG. 3, a rear end portion of the flange 111 is in contact with a front end portion of the sealing member 12, and thus the flange 111, for example, the rear end portion of the flange 111, serves a function as a stopper to prevent forward pushing of the sealing member 12 from the housing 11. The flange 111 is formed along the circumference of the front end portion of the housing 11 and extended in an outer direction from the front end portion. In addition, the flange 111 is provided to prevent the detaching of the sealing member 12 and thus, a height of the flange 111 is formed to be less than or equal to a height of the sealing member 12. Forming the flange 111 may enable prevention of the detaching of the sealing member 12 that may occur when the sealing member 12 is pushed by a force applied to the sealing member 12 when the housing 11 is connected to the mating connector. In addition, forming the flange 111 may enable prevention of detaching of the sealing member 12 along the housing 11 that may occur when the housing 11 is disconnected from the mating connector.

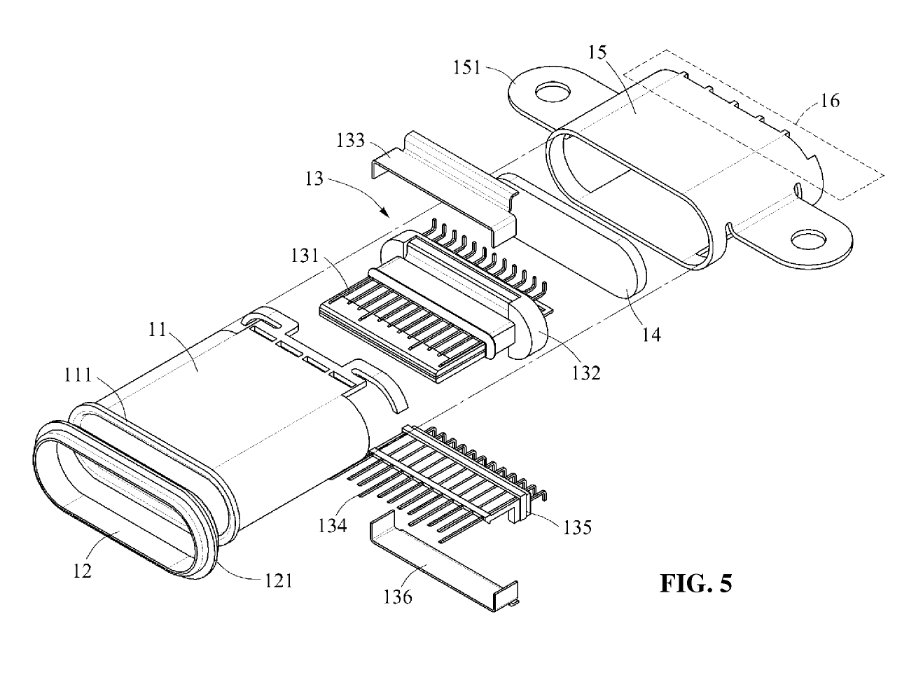

The terminal portion 13, as depicted in FIGS. 2, 3, and 5, is provided inside the housing 11, and a plurality of connection terminals, for example, a first connection terminal 131 and a second connection terminal 134, is disposed in a form of two layers. The terminal portion 13 includes a structure in which each of the two layers of the connection terminals 131 and 134 is inserted and molded to be connected. Referring to FIGS. 2 and 5, the terminal portion 13 includes an upper mold 132 formed by the first connection terminal 131 being inserted and molded, and a lower mold 135 connected below the upper mold 132 and formed by the second connection terminal 134 being inserted and molded. In addition, the terminal portion 13 includes a shield plate, for example, a shield plate 133 and a shield plate 136, to block electromagnetic waves. For example, the shield plates 133 and 136 may be provided on the upper mold 132 and below the lower mold 135, respectively. However, example embodiments may not be limited thereto, and practically various modifications may be made to a form and an assembling position of the shield plates 133 and 136.

A potting portion 14 is formed at a rear of the terminal portion 13 to seal the rear of the terminal portion 13 and the housing 11 for waterproofing. The potting portion 14 is formed by filling resin in the rear of the terminal portion 13 from a rear of the housing 11 as illustrated in FIG. 3 after assembling the terminal portion 13 and the housing 11, so that an inflow of water from the rear of the housing 11 and the rear of the terminal portion 13 may be prevented.

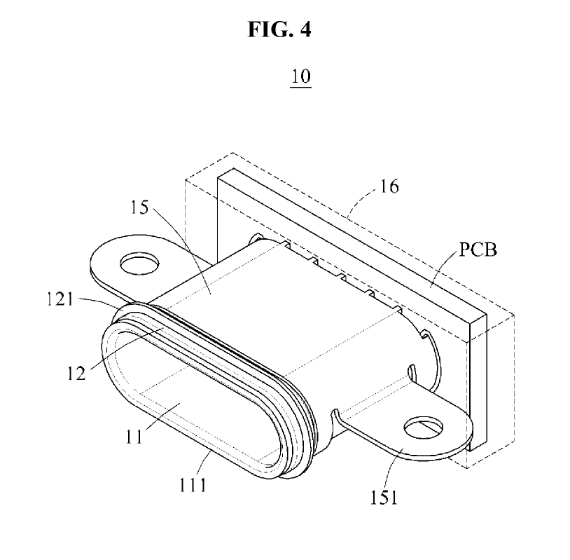

The terminal portion 13 is provided on the PCB or installed in the PCB in various forms. Hereinafter, a portion of the terminal portion 13 to be provided on the PCB will be referred to as a terminal connection portion 16. The terminal connection portion 16 may be modified to be in various forms based on a method through which the terminal connection portion 16 is provided in the PCB. For example, as illustrated in FIGS. 1-3, the connector assembly 10 may be provided on an upper surface of the PCB, and the terminal connection portion 16 may be provided on the PCB by a portion of the rear of the terminal portion 13 being bent at 90° downwards and the bent portion being provided on the PCB. In an alternative embodiment, as illustrated in FIG. 4, the connector assembly 10 may be provided perpendicularly to the PCB. In such a case, the terminal connection portion 16 may be formed in a direction extended from the terminal portion 13 without the rear of the terminal portion 13 being bent 90° downwards. However, example embodiments may not be limited thereto, and practically various modifications may be made to a form of the terminal connection portion 16 based on the method through which the connector assembly 10 is provided in the PCB.

For reference, the connector assembly 10 illustrated in FIGS. 4 and 5 is practically the same as the connector assembly 10 illustrated in FIGS. 1-3, excluding the form of the terminal connection portion 16. Thus, the same reference numeral and name are used and repeated descriptions will be omitted.

Dissimilar to example embodiments described with reference to FIGS. 1-5, FIGS. 6 and 7 illustrate an embodiment of the connector assembly 20 without a sealing member at a front end portion of a housing 21.

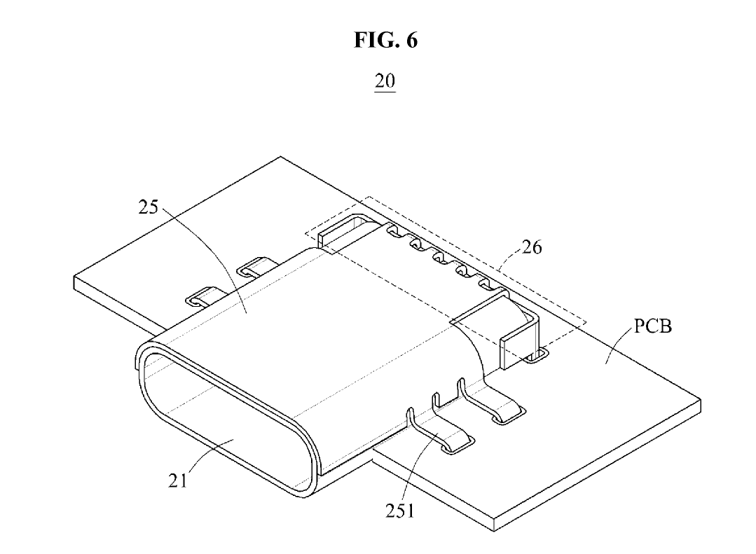

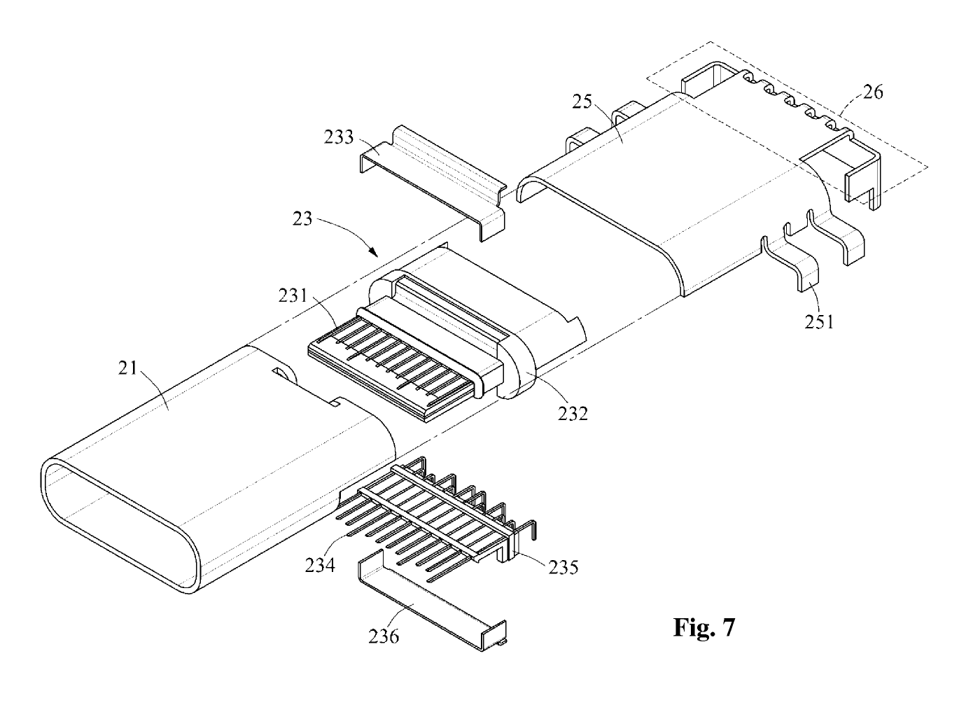

Referring to FIGS. 6 and 7, the connector assembly 20 includes the housing 21 in which a terminal portion 23 is provided, a cover shell 25 provided to cover the housing 21 and including a connecting portion 251 to be connected to a PCB, and a terminal connection portion 26 provided in the PCB from a rear of the terminal portion 23. Hereinafter, components of the connector assembly 20 practically the same as the components of the connector assembly 10 illustrated in FIGS. 1-5 will use the same names, and thus repeated descriptions will be omitted.

The housing 21 is provided in a form of an integral seamless tube to increase a waterproof efficiency. For example, the housing 21 may be formed in the integral form using a deep drawing. Alternatively, the housing 21 may be formed by bending a form of a plate formed through punching or bending to be in a cylindrical form, and by forming the cylindrical form to be an integral seamless cylindrical form by connecting positions to be attached to each other through welding or soldering. Dissimilar to example embodiments described above, a flange of the housing 21 is omitted due to an absence of the sealing member, and the cover shell 25 is connected to cover an entire portion of an upper surface of the housing 21.

The cover shell 25 is formed as a separate individual element from the housing 21, and formed to cover the entire portion of the upper surface of the housing 21 and also a side surface and a rear surface of the housing 21. The cover shell 25 includes the connecting portion 251 to be connected to the PCB. For example, the connecting portion 251 is formed by a portion of a side surface of the cover shell 25 being extended in an outer direction to be connected to the PCB and an end portion of the cover shell 25 being bent downwards. However, example embodiments may not be limited to the illustrated example, and practically various modifications may be made to a form of the cover shell 25.

The terminal portion 23 is provided inside the housing 21, and a plurality of connection terminals, for example, a connection terminal 231 and a connection terminal 234, is disposed in a form of two layers. Each of the two layers of the connection terminals 231 and 234 is inserted and molded to form an upper mold 232 and a lower mold 235, respectively, and the upper mold 232 and the lower mold 235 are connected. In addition, a shield plate, for example, a shield plate 233 and a shield plate 236, is provided on the upper mold 232 and below the lower mold 235.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Suitable results may be achieved if the described techniques are performed in a different order, and/or if components in a described system, architecture, device, or circuit are combined in a different manner, and/or replaced or supplemented by other components or their equivalents. Therefore, the foregoing description should be regarded as illustrative rather than limiting, and the scope of the invention is defined by the claims together with their full range of equivalents.

What is claimed is:

1. A connector assembly, comprising:
a housing in a form of a seamless tube;
a terminal portion disposed inside the housing and including a plurality of connection terminals;
a sealing member disposed along a circumference of a front end portion of the housing, the front end portion of the housing connecting to a mating connector;
a flange formed at the front end portion of the housing adjacent to the sealing member; and
a cover shell covering an outer side of the housing.

2. The connector assembly of claim 1, wherein the flange protrudes in an outer direction along the circumference of the front end portion of the housing, a rear end portion of the flange being in contact with a front end portion of the sealing member.

3. The connector assembly of claim 2, wherein the flange is formed continuously along the circumference of the housing.

4. The connector assembly of claim 2, wherein the flange is formed discontinuously along the circumference of the housing.

5. The connector assembly of claim 2, wherein a height of the flange is less than or equal to a height of the sealing member.

6. The connector assembly of claim 2, wherein a front end portion of the cover shell is in contact with a rear end portion of the sealing member.

7. The connector assembly of claim 1, wherein the sealing member comprises a protrusion on an outer circumference surface, and wherein the protrusion is formed to be orthogonal to a mating direction.

8. The connector assembly of claim 7, wherein the protrusion is formed continuously along a circumference of the outer circumference surface of the sealing member.

9. The connector assembly of claim 7, wherein the protrusion is formed discontinuously along a circumference of the outer circumference surface of the sealing member.

10. The connector assembly of claim 1, wherein the housing is formed using a deep drawing.

11. The connector assembly of claim 1, wherein the housing is formed with seams bound together through welding or soldering.

12. The connector assembly of claim 1, wherein the terminal portion comprises a sealing potting portion at a rear of the terminal portion.

13. The connector assembly of claim 1, wherein the plurality of connection terminals in the terminal portion is disposed in a two layer form.

14. The connector assembly of claim 13, wherein the terminal portion comprises:
a plurality of first connection terminals;
an upper mold in which the first connection terminals are inserted;
a plurality of second connection terminals disposed below the first connection terminals; and
a lower mold in which the second connection terminals are inserted and connected to the upper mold.

15. The connector assembly of claim 14, wherein the terminal portion comprises a plurality of shield plates on outer sides of the terminal portion.

16. The connector assembly of claim 15, wherein the plurality of shield plates are provided at least above the upper mold and below the lower mold.

17. The connector assembly of claim 1, wherein the cover shell further comprises a connecting portion connecting the connector assembly to a printed control board, and wherein the connected printed control board is parallel to a direction in which the housing is connected to the mating connector.

18. The connector assembly of claim 1, wherein the connector assembly is connected to a printed control board, and wherein the connected printed control board is orthogonal to a mating direction.

19. A connector assembly, comprising:
a housing in a form of a seamless tube;
a terminal portion disposed inside the housing and including a plurality of connection terminals; and
a cover shell formed as a separate individual element from the housing and disposed to cover an outer side of the housing, wherein the cover shell covers at least an entire portion of an upper surface of the housing at a front end portion of the housing, the front end portion of the housing connecting to a mating connector.

20. The connector assembly of claim 19, wherein the cover shell further comprises a connecting portion connecting the connector assembly to a printed control board.
